(19) United States
(12) Patent Application Publication
(10) Pub. No.: US 2025/0080039 A1
(43) Pub. Date: Mar. 6, 2025

(54) EXPANDABLE SOLAR PANEL ARRAY

(71) Applicant: Dartsolar LLC, Los Angeles, CA (US)

(72) Inventors: OMID SADEGHPOUR, Los Angeles, CA (US); THOMAS MANFREDONIA, Agoura Hills, CA (US); JERAN BRUCE, Los Angeles, CA (US)

(73) Assignee: Dartsolar LLC, Los Angeles, CA (US)

(21) Appl. No.: 18/827,669

(22) Filed: Sep. 6, 2024

Related U.S. Application Data
(60) Provisional application No. 63/558,776, filed on Feb. 28, 2024.
(60) Provisional application No. 63/596,964, filed on Nov. 7, 2023.
(60) Provisional application No. 63/536,698, filed on Sep. 5, 2023.

(51) Int. Cl. H02S 20/30; B60L 8/00; H02S 30/20

(52) U.S. Cl. CPC H02S 20/30; H02S 30/20; B60L 8/003

(57) ABSTRACT

A solar panel array is disclosed which utilizes a frame, a plurality of telescoping arms, a plurality of solar panels supported by said telescoping arms, and a control system. These components work together to provide a solar panel array that can expand and contract and is designed for use on a vehicle or automobile. The solar panel array is intended to provide a substantial amount of electrical energy to the vehicle's propulsion system, recharge the vehicle's batteries, and power auxiliary systems.

### CROSS-REFERENCE TO RELATED APPLICATIONS

This application claims the benefit of U.S. Provisional Patent Application No. 63/536,698, filed on Sep. 6, 2023, U.S. Provisional Patent Application No. 63/596,964, filed on Nov. 7, 2023, and U.S. Provisional Patent Application No. 63/558,776, filed on Feb. 28, 2024, and incorporated herein by reference.

### STATEMENT REGARDING FEDERALLY SPONSORED RESEARCH AND DEVELOPMENT

Not Applicable.

### FIELD OF THE INVENTION

This invention relates generally to a solar array for producing renewable energy for an vehicle, and more particularly, to an expandable and contractable solar panel array designed for installation on the rooftop of an electric vehicle.

### DISCUSSION OF RELATED ART

Traditionally, vehicles have relied on internal combustion engines or more recently on battery-operated electric motors for propulsion. While electric vehicles offer a significant improvement in reducing greenhouse gas emissions compared to their fossil fuel counterparts, the problem of range limitation due to battery capacity persists. This issue is further exacerbated by the long time required for recharging the vehicle's batteries. Users aiming for net-zero greenhouse gas emissions face limited options for environmentally friendly vehicle charging. Furthermore, campers and other outdoor enthusiasts have limited compact solar solutions that can offer a high watt output to provide them with continuous off-grid power.

Solar energy has long been considered a sustainable alternative energy source. However, conventional solar panel installations are typically stationary and require significant surface area to generate enough energy for practical applications. Given these limitations, the integration of solar panels onto vehicles has been challenging.

Several solutions exist in the prior art for mounting solar panels on vehicles, either as an aftermarket accessory or as part of the original vehicle. However, these existing solutions generally suffer from various drawbacks, including but not limited to: low wattage output, impractical design leading to reduced aerodynamic performance, lack of durability to withstand environmental conditions encountered during vehicle operation (e.g., rain, snow, wind, etc.), and limited scalability or modularity to suit different types and sizes of vehicles.

As electric vehicles become increasingly popular, the demand for efficient and portable energy sources has grown. Traditional rooftop solar panels, while useful, often do not provide sufficient energy to meet the demands of an EV due to limited surface area. Additionally, conventional rooftop solar panels are fixed in position, limiting their ability to capture optimal sunlight throughout the day. Therefore, there is a need for a solar panel system that can expand to capture more sunlight and contract for portability, particularly when mounted on vehicles. The present invention satisfies these needs.

While some options exist for providing renewable energy to vehicles, they are not sufficient to meet the demands of an electric vehicle. Therefore, a need exists for a solar panel system that can expand to capture more sunlight and contract for portability, particularly when mounted on vehicles. The present invention satisfies these needs.

### SUMMARY OF THE INVENTION

The present invention will provide a solar panel array capable of expanding and contracting on the rooftop of a vehicle. This solar panel array comprises a frame to which a plurality of telescoping arms are attached. The most basic of telescopic arms used in the present invention consists of concentric round tubes held within each other, with over expansion locks such that the telescopic arm does not disembody when expanded. Solar panels are mounted on these telescoping arms, enabling the panels to extend or retract based on the user's needs. The array is designed to be installed on the rooftop of a vehicle, with the capability of expanding to increase surface area for solar energy capture when the vehicle is stationary and contracting to a compact form when the vehicle is in motion.

The system includes various features such as safety locks, over-extension locks, and a control system with linear actuators for automatic operation. Additionally, the solar panels can be bifacial and are enclosed in a durable, transparent coating to protect against environmental conditions. The system also includes an electrical system that connects to the vehicle's charging systems, allowing for energy transfer to the vehicle's battery.

Moreover, the control system is equipped to monitor the state of the vehicle, receive external triggers via an API or app, and use decision-making rules to control the expansion and contraction of the solar panels. Alternative embodiments provide for different configurations and placements of the solar modules, offering adaptability to various vehicle types.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

FIG. 1 is a diagram illustrating a top perspective view of the solar panel array attached to a vehicle according to one embodiment of the invention;

FIG. 2 is a front view thereof;

FIG. 3 is a side view thereof;

FIG. 4 is a top view thereof;

FIG. 5 is a top perspective view of the solar panel array attached to a vehicle with all panels contracted;

FIG. 6 is a top perspective view thereof without vehicle;

FIG. 7 is a top perspective view of the solar panel array attached to a vehicle with only one solar module attached and expanded;

FIG. 8 is a top perspective view of the solar panel array attached to a vehicle with three solar module attached and expanded;

FIG. 9 is a top perspective view of the solar panel array without solar panels and contracted;

FIG. 10 is a bottom view thereof;

FIG. 11 is a top perspective view of a solar panel module and expanded;

FIG. 12 is a top view thereof;

FIG. 13 is a side view thereof;

FIG. 14 is a top perspective view thereof without solar panels;

FIG. 15 is a top view thereof;

FIG. 16 is a side view thereof;

FIG. 17 is a cross-sectional view taken along line A-A of FIG. 15 showing the telescoping arms in contracted form;

FIG. 18 is a cross-sectional view taken along line A-A of FIG. 15 showing the telescoping arms in expanded form;

FIG. 19 is a front perspective close-up view showing the winglet in more detail;

FIG. 20 is a perspective close-up view showing the over-extension locks in more detail;

FIG. 21 is a cross-sectional view taken along line B-B of FIG. 15 showing the C-channel in more detail;

FIG. 22 is an image of a mechanical and linear actuator;

FIG. 23 is an alternative image of a mechanical and linear actuator in contracted form; and

FIG. 24 is an image thereof in expanded form.

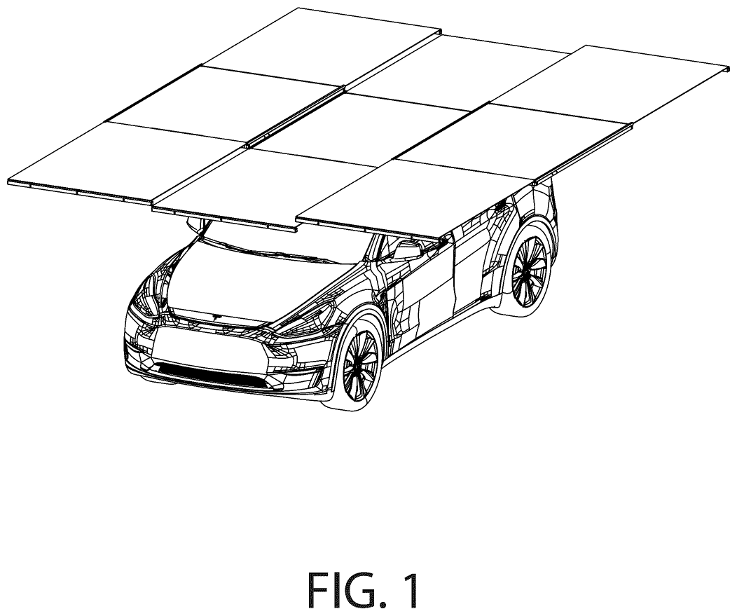

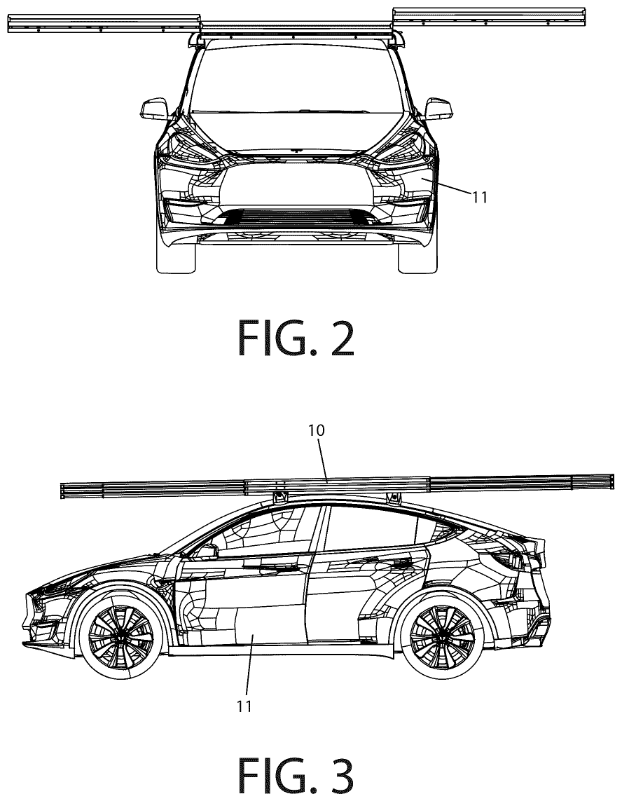

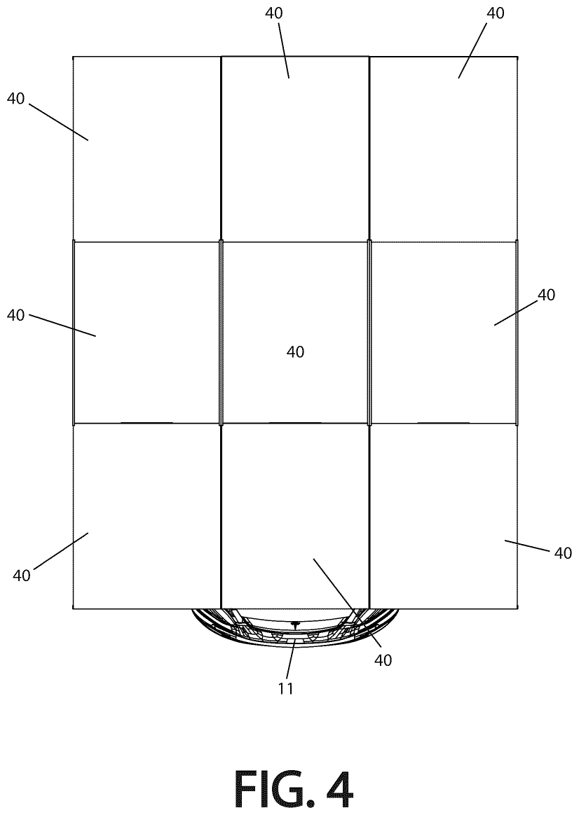

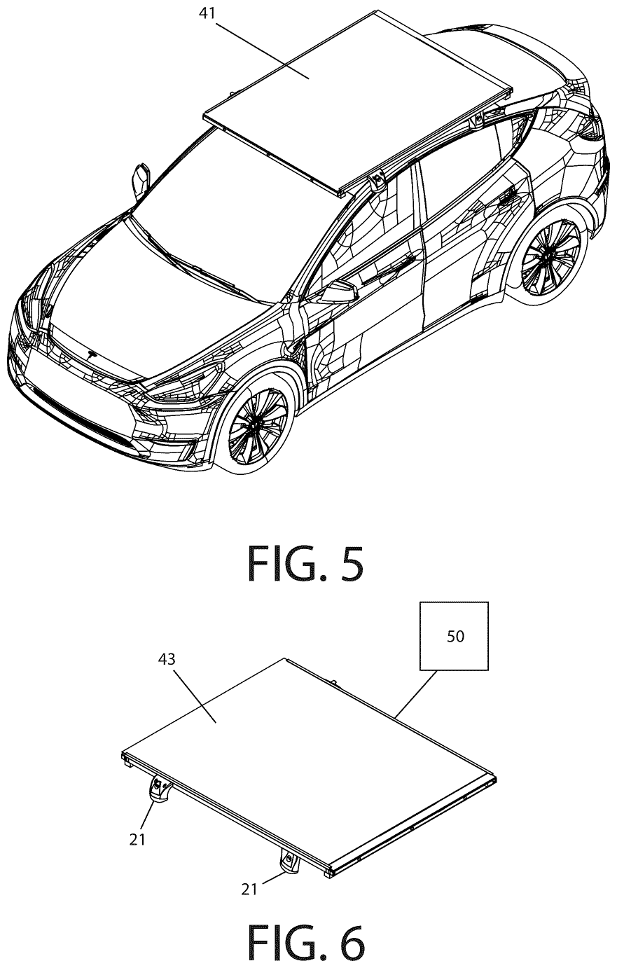

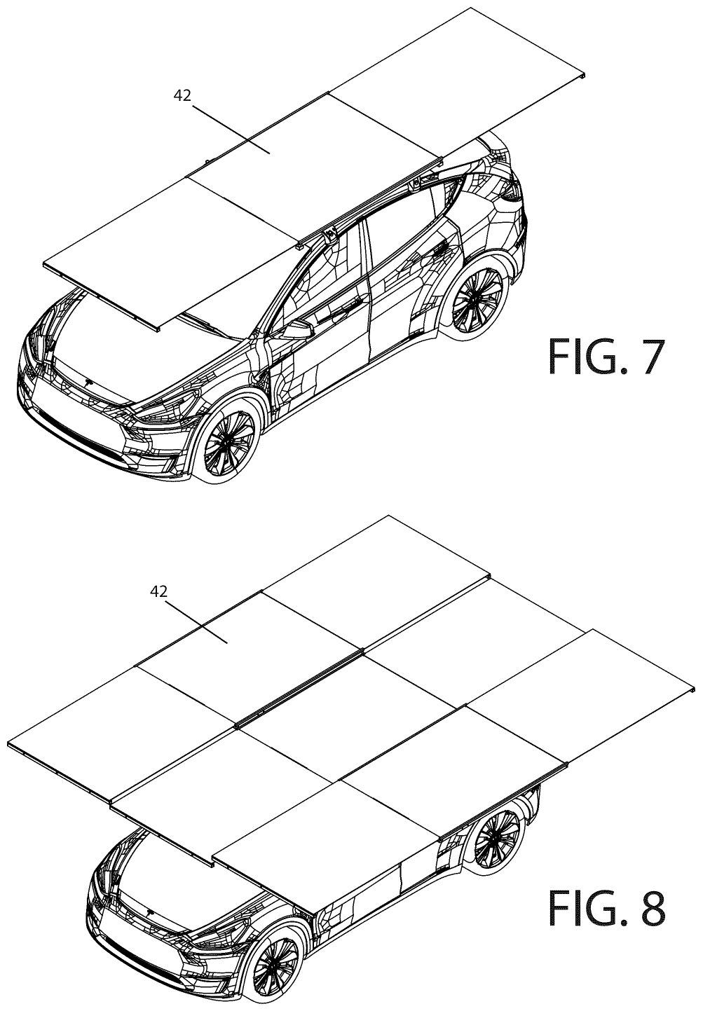

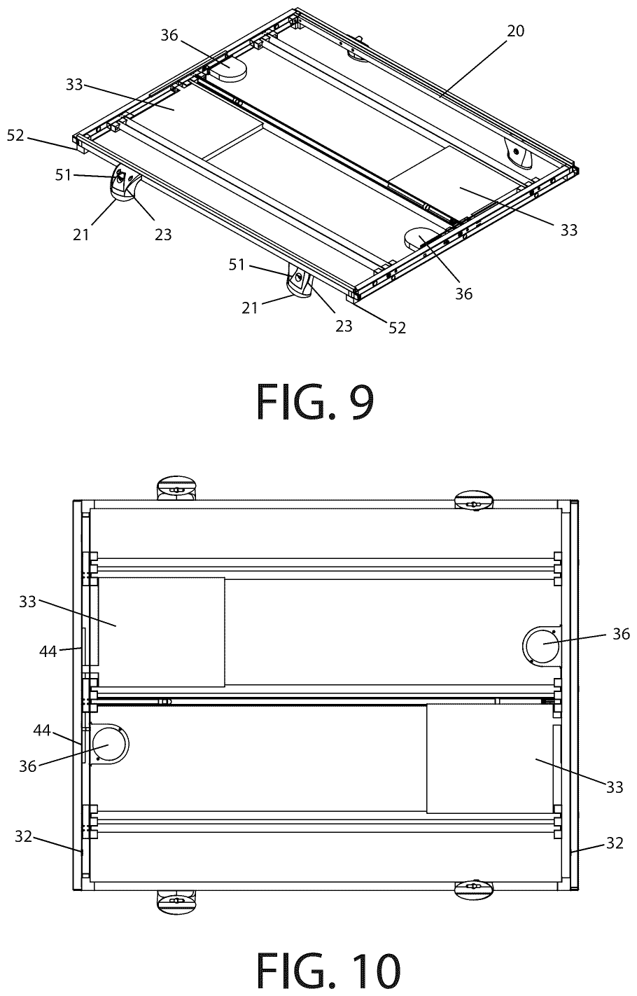

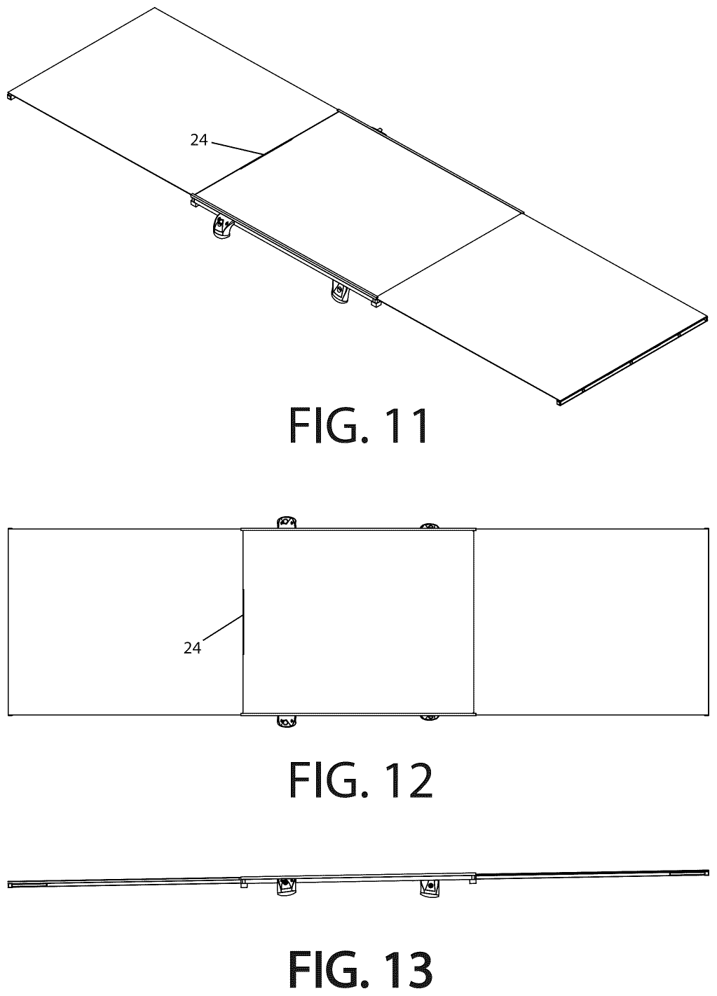

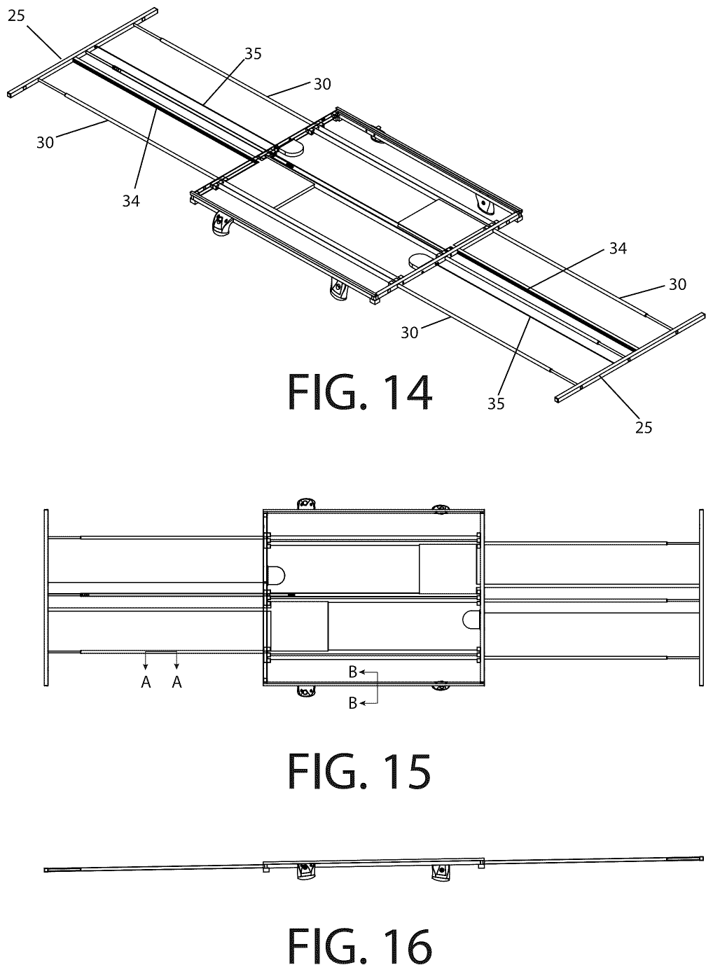

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The present invention comprises a solar panel array 10 comprising a frame 20, a plurality of telescoping arms 30, a plurality of solar panels 40 supported by said telescoping arms 30, and a control system 50. These components work together to provide a solar panel array 10 that can expand and contract and is designed for use on a vehicle 11 or automobile. The solar panel array 10 is intended to provide a substantial amount of electrical energy to the vehicle's propulsion system, recharge the vehicle's batteries, and power auxiliary systems.

The frame 20 provides a means for the solar panel array 10 to attach to a vehicle 11. More specifically, the solar panel array 10 is mounted on a frame 20 that can be affixed to the roof of the vehicle 11 via a set of roof mounts 21. These mounts 21 are designed to distribute weight evenly and are cushioned to protect the vehicle's surface. Alternatively, the frame 20 can be configured to non-permanently attach to an existing roof rack. The frame 20 itself is made of lightweight yet robust materials such as aluminum, carbon fiber composites, or other composites to ensure durability without significantly adding to the weight of the vehicle. Integrated into the frame 20 are a plurality of C-channels 22, which guide the solar panels 40 during their expansion and contraction.

The solar panels 40 are mounted on a plurality of telescoping arms 30. These telescoping arms 30 are connected to said frame 20 and are configured to extend parallel to the plane of the vehicle's rooftop, allowing the solar panels 40 to expand outward from all sides of the vehicle 11. The telescoping arms 30 are equipped with over-extension locks to prevent damage from the over-expansion of the solar panels 40.

To ensure safe operation, the present invention includes a plurality of safety locks 32 that prevent accidental expansion of the solar panels 40 and telescoping arms 30 while the vehicle 11 is in motion. Additionally, a spring-loaded retracting electrical cable mechanism 36 manages the cables 35 that transfer the power generated by the solar panels 40 to the vehicle 11. Furthermore, the solar panels 40 used in this solar panel array 10 can be bifacial, meaning they are capable of generating electricity from sunlight on both sides. The solar panels 40 are designed to be thin, flexible, and lightweight, enclosed in a durable, transparent coating to protect against environmental conditions.

The control system 50 is integral to the solar panel array 10, providing a means for charging the vehicle's battery from the solar panels 40. The solar panels 40 can be connected in series or parallel depending on the vehicle's charging needs. The control system 50 is also equipped with a means for direct connection to the vehicle's charging system without the need for an external charging port.

The control system 50 comprises a central processing unit (CPU) with onboard memory and storage. This control system 50 is configured to interact with a software layer, enabling programmatic control and remote triggering of the expansion and contraction of the solar panels 40 through mechanical and electrical linear actuators 33. The control system 50 can communicate with the vehicle 11 and external devices via wired or wireless communication channels.

The control system 50 can further configured to monitor the state of the vehicle 11, such as whether it is stationary or in motion, to determine when to expand or contract the solar panels 40. It can also receive external triggers via an API or a mobile app, allowing the user to control the solar panel array 10 remotely. Additionally, the present invention incorporates decision-making rules to automatically perform actions based on the inputs received, ensuring safe and efficient operation.

In an alternative embodiment, the present invention further comprises two or a plurality of 180-degree cameras 51, one on the passenger side and one on the driver side. In another embodiment, the structure includes four or a plurality of cameras 51, one on each corner of the frame 20. These cameras 51 connect to the CPU of the vehicle 11 or the solar array 10, allowing the programmatic layer to sense the available space surrounding the vehicle 11. This information ensures that the specific solar panels 40 are deployed safely, avoiding obstacles and optimizing sunlight capture.

The present invention further comprises adjustable roof connectors 23 mechanically and/or removably attached to the frame 20 and the vehicle 11. These roof connectors 23 allow the angle of the frame 20 to be adjusted to maximize sunlight capture based on the sun's position.

The present invention further comprises a plurality of junction boxes 44, where each of said plurality of junction boxes 44 is electrically connected to each of said plurality of solar panels 40. These junction boxes 44, or diodes, are strategically positioned within the frame 20 to facilitate easier stacking of the solar panels 40 when they are in the contracted state.

Now going into more detail into the operation of the present invention, there are two modalities; a ‘contracted’ modality 41 and an ‘expanded’ modality 42. In the contracted modality 41, all of said plurality of solar panels 40 are stored one on top of each other and only the top most solar panels 40 can receive sunlight. In the expanded modality 42, all the solar panels are deployed and can receive sunlight. The contracted modality 41 is also referred to as the ‘undeployed’, ‘disabled’, or ‘closed’ modality. The expanded modality 42 is also referred to as the ‘deployed’, ‘enabled’, or ‘open’ modality. The present invention can also exist in a mixed state, in which some of the solar panels 40 are expanded, but not all.

The present invention has four layers from bottom to top. The bottom layer or “bottom frame” contains the telescopic arms 30 that expand laterally both toward the sides of the vehicle. The telescopic arms 30 of the bottom frame support most of the weight of the layers above when in expanded form 42. As the weight of the layers above increase, more telescopic arms 30 that can expand laterally can be added to this bottom layer without changing the overall dimensions of the present invention, while increasing the maximum weight bearing capacity of the present invention.

For the remainder of this description, the term ‘longitudinally’ refers to the axis that points in the direction of travel of the vehicle 11. The term ‘laterally’ refers to the axis that points perpendicular to the direction of travel of the vehicle 11. Both the longitudinal and lateral axes form a plane that is parallel to the rooftop of the vehicle 11.

The second layer from the bottom is a solar module 43 that contains three solar panels 40. This solar module 40 first expands laterally toward the side of the vehicle 11, and subsequently expands longitudinally in both directions. In said solar module 43, the solar panel 40 that does not expand longitudinally is called the static solar panel. As the weight and size of the individual solar panels 40 of this layer increase or decrease more longitudinal telescopic arms 30 can be added or removed from this layer.

The third layer from the bottom is also a solar module 43 that also contains three solar panels. This solar module 43 first expands laterally (in the opposite direction as the second layer), and subsequently expands longitudinally in both directions. The solar panel 40 that does not expand longitudinally is also called the static solar panel. As the weight and size of the individual solar panels 40 of this layer increase or decrease, more longitudinal telescopic arms 30 can be added or removed from this layer.

The top most layer or top solar module 43 also contains three solar panels 40. This solar module 43 does not move laterally; it can only expand longitudinally. The solar panel 40 that does not expand is also called the static solar panel. The top most longitudinal moving solar panel 40 of this solar module 43 is always enabled as it is always facing the sun and charging the power unit connected to the present invention. As the weight and size of the individual solar panels 40 of this layer increase or decrease, more longitudinal telescopic arms 30 can be added or removed from this layer.

Expanding laterally first has many benefits. First, it is much easier for the user to pull the solar module 43 in the lateral direction because the user is not blocked by the trunk or the hood of the vehicle 11. The first pull moves an entire solar module 43 which contains three solar panels 40, as such, it requires more force. If the first pull was in the longitudinal direction, then the user needs to exert a lot of force moving an entire solar module 43 over the hood or trunk of the vehicle 11.

The second benefit is a mechanical one. Given the orientation of the present invention on a vehicle 11, if the invention is expanded first longitudinally, then because of the cantilever arm and three-panel weight of the solar module 43, more weight needs to be supported by the telescopic arm 30.

In an alternative embodiment, the second and third layer solar modules 43 expand longitudinally first, and laterally second. This alternative design lends itself to vehicles 11 of odd shapes where the user can exert more force pulling or pushing longitudinally.

Given that the present invention is composed of three solar modules 43 one on top of each other and a bottom layer of telescopic tubes 30 for lateral expansion, the proceeding explanations will now focus on the details of a single solar module 43.

In contracted modality 41, the present invention is light and compact enough such that it can be safely attached to the rooftop of a vehicle 11. In contracted modality 41, the present invention can also be used to store solar panels 40 in a dense and compact way, such that it can be expanded 42 when electrical power needs arise. The ease of transporting and storing the present invention for long periods of time requires that the materials and construction mechanisms used can: (1) endure the long-term vibrations of a moving vehicle, and (2) the temperature ranges of storage facilities.

### Solar Module 43

The spirit of the present invention is such that a solar module 43 can expand in phases to cover regions that are available around the vehicle 11. Specifically, it allows for each of the dynamic solar panels 40 to expand independently, instead of forcing all the solar panels 40 to be deployed at once. For example, if only the rear of the vehicle 11 has clearance, then only the rear dynamic expanding solar panel 40 can be deployed while the remainder of the solar panels 40 remain contracted.

In an alternative embodiment, a single solar module 43 with three solar panels 40 is attached to the roof of a vehicle 11. In a yet alternative embodiment, the orientation of such solar module 43 is such that the solar panels 40 expand only laterally instead of longitudinally.

In an alternative embodiment, two solar modules 43 are attached to the roof of a vehicle 11. In such a configuration, one or both of the solar modules 43 expand laterally first, and longitudinally second. For this configuration, a bottom layer composed of bi-directional telescopic arms 30 is necessary to enable the solar modules 43 to extend laterally.

### Telescoping Arms 30

The telescoping arms 30, or concentric shape telescopic tubes, provide a means for the solar panel array 10 to expand and contract, enabling the ability to increase or decrease size of the solar panel array 10 according to the needs of the user or the conditions of use. Each telescoping arm 30 consists of several interlocking segments made from a durable material like stainless steel, aluminum, carbon fiber, or plant-based fiber.

Unlike standard sliders, telescopic arms 30 can expand two-fold or ten-fold in length without dramatically increasing their weight. The weight of a telescopic arm 30 plateaus somewhat following the log-function with the length it expands, whereas the weight of sliders increases with the length it expands. Telescopic arms 30 provide greater support and restraint at a lower weight-to-load ratio compared to sliders. Further, by changing the concentric shape of a telescopic arm 30 (i.e.: circular, vs. oval, vs. square vs. triangle), more support can be provided in a given direction. By (1) varying the concentric shape of a telescopic arm 30, (2) varying the weave direction or pattern of the carbon fiber, and (3) varying the thickness of selected arms-the strength and direction of a telescopic arm 30 can be modified and optimized for the needs of the invention.

The telescoping arms 30 may comprise any shape, so long as the telescoping arms 30 are able to expand and contract as required by the present invention. In the preferred embodiment, the telescoping arms 30 comprise a circular shape. In an alternative embodiment, the telescoping arms 30 comprise an oval shape. In a further alternative embodiment, the telescoping arms 30 comprise a square or rectangular shape.

In the present invention, each telescoping arm assembly further comprises a plurality of telescoping arm sections 26, wherein each telescoping arm section 26 has a proximal end and a distal end. Attached at the proximal end is a guide-ring 28 on the outside of the tube that allows for smooth, straight operation as said section 26 expands and contracts, and to prevent over-extension. Attached at the distal end is a guide-ring 27 inside of the tube to lock with the proximal guide-ring 28 of the contained telescopic section 26, and so on.

The guide-rings 27, 28 need to be modified to decrease friction when the telescopic arm 30 is under a moment load, or under a bending load. In the preferred embodiment the friction coefficient of the guide-ring is reduced to near zero. In the present invention, the use of micro ball bearings embedded within the guide-rings allows for the telescopic arms 30 to expand and contract under the bending load that may be caused by external conditions, such as high winds. In the present invention, in the distal and proximal ends of each telescopic arm section 26 there are micro ball bearings. On the proximal end, micro ball bearings are embedded onto a spherical widget that is screwed into the tube, on the distal end the micro ball bearings are either held within the solar module frame 20, or embedded into a guide-ring that is screwed into the tube.

Each telescopic arm section 26 further comprises a plurality of over-extension locks. The over-extension locks are the guide rings 27, 28 that prevent the telescopic arm sections 26 from overextending. If the telescopic arm section 26 overextends, then the telescopic arm bends at the joints under a bending load. As such, the over-extension locks ensure that each telescopic arm section 26 overlaps by about 15%, ensuring that the joins are rigid and prevents the telescopic arm 30 from bending. In the preferred embodiment, the over-extension locks are stopper rings. Here, the stopper-rings are attached at 15% the length of the telescopic section 26 from the proximal end toward the distal end. The stopper-ring is attached to the outside of the telescopic arm section 26 that it stops, consequently the stopper-ring's diameter is the same as the outer diameter of the same section 26. The thickness of the stopper-ring is such that it does not touch the inner diameter of the preceding telescopic arm section 26, but it is thick enough to collide with the distal guide-ring 27 of the preceding telescopic arm 30.

In the preferred embodiment, two C-channels 22 are used to ensure the solar panels of a solar module 43 expand only in the direction they are intended to. The C-channels 22 lie on top of the solar module frame 20 and hug the solar panels 40 from the lateral edges. As such, when a solar panel array 10 expands 42, it is guided by both C-channel rails. The C-channel 22 also aids in the contraction of the solar panels 40. As the solar module 10 contracts 41, the C-channels 22 ensure the solar panels 40 are guided toward their end position. The C-channels 22 also ensure that the flexible solar panels 40 do not bend and flex in the Z-axis (upward or vertically relative to the vehicle) when the vehicle 11 is in motion. The top part of the C-channel 22 always blocks the solar panels 40 from flexing upwards.

In an alternative embodiment, the present invention comprises a hard-shell top allowing the user to store heavy equipment on the solar modules 43 without damaging the solar panels 40. Once the heavy equipment is removed, the hard-shell top can also be removed allowing the solar modules 43 to expand 42. In the present invention, such hard-shell is supported by the C-channel rails. The C-channels 22 are connected to the frame 20 of the solar module 43, and a ⅛-inch mesh of stainless steel can be placed and locked on the C-channels 22.

In an alternative embodiment, as the solar panels 40 of a solar module 11 contract 41, they are bound to collide with one another at the edge that is most distant from the handlebar 25. To ensure that a solar panel 40 always goes over the other solar panels 40, a winglet 24 is used. The winglet 24 is attached to the collision end of both solar panels 40. When seen from the side, the winglet 24 of one solar panel 40 is composed of a triangular end that is pointing downwards, while the winglet 24 of the opposing solar panel 40 points upward. As such, when the solar module 43 is collapsing from an expanded position, both winglets 24 will collide first ensuring that the correct solar panel 40 always ends as the top most solar panel 40. Besides ensuring the correct solar panel 40 ends on top during the contraction of a solar module 43, the winglets 31 act as a redundant mechanism to prevent over extension. The primary over-extension locks exist in the telescopic arms 30 and their guide-rings 27, 28. Since the winglets 24, 31 are at the collision edge of each solar panel 40, they are the secondary over-extension locks. When the winglet's solar panel edge slides to the edge of the solar module frame, full expansion has been completed. On the such edge of the solar module frame there is a blocking flap that collides with the winglet 31 if the solar panel is over extended.

In an alternative embodiment, safety locks 32 are provided to prevent the solar modules 43 from accidentally expanding while the vehicle 11 is in motion. Accidental expansion of the present invention could result in a vehicle accident as the present invention meant to be in contracted form when mounted on a moving vehicle. More specifically, the safety locks 32 are mechanical locks that the user must disengage prior to use. In a preferred embodiment, such locks are latches, hinges, magnets, or the like, and connect the edge of the static frame of the solar module 43 with the handlebar 25. Each side has two such locks for redundancy. The safety locks 32 are positioned in the front and rear face of each solar module 43. In an alternative embodiment, safety locks 32 can be engaged and disengaged electronically, allowing for electrical controllers to unlock the solar modules 43 automatically prior to expanding 42 the solar modules 43 via automated actuators. The same logic applies in reverse order when the solar modules 43 need to be contracted 41.

### Solar Panels

A plurality of high-efficiency photovoltaic solar panels 40 are attached to the plurality of telescoping arms 30. Depending on the size of the vehicle 11, the number of solar panels 40 and their respective wattage can vary. These solar panels 40 are made of mono-crystalline or poly-crystalline silicon cells, known for high energy conversion efficiency. Each solar panel 40 is enclosed in a durable, transparent coating to protect against environmental conditions such as rain, dust, and wind. In a preferred embodiment, these solar panels 40 are flexible, where each solar panel 40 can generating at least 100 watts. In an alternative embodiment, the solar panels 40 are bifacial, where sunlight can be converted into electricity on both sides of the solar panels 40. In an alternative embodiment, the solar panels 40 do not only use silicon wafers, but can also be CIGS solar panels or use Perovskites.

The present invention, its solar modules 43, and solar panels 40 are designed with aerodynamics in mind. When in a contracted modality 41, the low height profile of the present invention reduces aerodynamic drag-this is critical for maintaining power efficiency in vehicles 11 as they move. In all figures, the solar panels 40 appear as rectangular or square plates, however, each of these plates can be further composed of a number of smaller solar panels or cells to ensure a low cost and repairable system. In the sense that, in the harsh conditions that a vehicle may undergo, a solar cell or solar panel 40 may get damaged. As such, it would be less costly to replace a smaller solar panel 40 than the entirety of the plate in the figures.

Each solar panel 40 comprises one or a plurality of junction boxes 44. Junction boxes 44 are small devices that contain a diode, such that electrical current can bypass a faulty region of a solar panel 40. Each junction box 40 is connected to a charge controller or “power unit”, which regulates the voltage and current that the solar panels 40 supply to the vehicle's batteries or charging systems. In the preferred embodiment, the solar panels 40 provide a DC-DC connection to the vehicle's batteries via a power unit. In an alternative embodiment, there is DC-to-AC conversion in the power unit, where an inverter is used to convert the DC power from the solar panels 40 to an AC output suitable for a vehicle charger. In both cases, electrical components necessary to convert the solar power 40 to a stable voltage and current that a vehicle 11 are found in the control system 50. MPPT solar charge controllers, power converters, intermittent batteries, inverters, CCS1 modems and other equipment may needed to satisfy the needs of the user and are all anticipated by the present invention.

In the preferred embodiment, a fully integrated power unit would include electronics that receive the solar power using MPPT technology, converts that solar power to a DC voltage interoperable with the electric vehicle's battery, and communicates with the vehicle with a CCS1 protocol to initiate a DC-charging session. DC charging has the advantage that it eliminates the added conversion step from DC to AC power. Elimination of such step leads to a more efficient use of the power generated from the solar panels 40. In an alternative embodiment, when communication protocols and standards change, such new protocols would be used.

In an alternative embodiment, and in an effort to decrease the height profile of the present invention, the solar panel junction boxes 44 are removed and positioned elsewhere. Here, each solar panel 40 has at least one junction box 44, such that if a solar panel 40 is in the shade, current from the other solar panels 40 will still flow. In an alternate embodiment, each solar panel 40 will have as many possible junction boxes 44 allowing greater energy production even when areas of such solar panels 44 are shaded. In an alternative embodiment, half-cell or quarter-cell solar panels with more junction boxes 44 can be used. In an alternative embodiment, other solar panel junction box technologies such as bifacial or Perovskite solar cells may be used.

In an alternative embodiment the junction boxes 44 are stored externally, for example, in the trunk of a vehicle 11. Storing the junction boxes 44 in the trunk of the vehicle 11 allows the user to dynamically change the series and parallel connections of the regions of the solar panels 40 depending on the specifications of the attached power unit. For higher voltage systems, the solar panel regions can be connected in series, for higher current systems the solar panel regions can be connected in parallel, or any allowed permutation thereof. If solar panel regions get shaded, a real-time power optimization mechanism can dynamically change the series and parallel connectivity of said junction box regions. The main disadvantage of this design is that many more wires need to expand, contract, and be funneled from the solar panel regions to external location where the power unit resides. Another disadvantage is the loss of power due to the resistance of all the excess wiring. The main advantage of this approach is that the height of the present invention can be as low as possible.

In an alternative embodiment, the junction boxes 44 of a solar panel 40 are stored in the front and rear facing handlebars 25 of the solar module 43. This design has the added benefit that fewer wires need to expand and contract from the solar module frame to the extremities of the invention when in expanded form. For example, a solar panel 40 might use four junction boxes 44 to control energy production on four sections of the panel. By storing all the junction boxes 44 on the handlebar 25, only two wires need to expand and contract into the respective solar module frame, instead of eight wires (two wires for each junction box).

In an alternative embodiment, the junction boxes 44 are stored in the solar module frame. The benefit of this design is that the junction boxes 44 do not need to move longitudinally, and fewer wires need to be funneled to the power unit.

In an alternative embodiment, electrical connections between the solar panels 40, charge controller, and the vehicle's electrical system 50 are facilitated through high-conductance cables designed to minimize energy loss. These cables 35 are connected to a power unit that can feed said power into the vehicles charge port receptacle in AC or DC form.

In the present invention, to enable the expansion 42 and contraction 41, cables 35 carrying power from the solar panels 40 need to extend and contract longitudinally at least the length of a solar panel 40. When such cables 35 extend or contract, a cable extending mechanism 36 is enabled to ensure no cables are left sagging or dangling from the present invention. Such cable extending mechanisms 36 need to have a cable storage and cable pulling function.

In the preferred embodiment, the cable extending mechanism used is a reel-driven retractable cable system. Such reel-driven systems use a slip ring to ensure electrical current can flow at all times when cables 35 are being rolled and stored in a circular and rotating cartridge. Such reel-driven systems also use a coil spring to ensure there is a constant pulling force or tension the cable 35. In an alternative embodiment, each solar module 40 has two reel-driven retractable cable systems, one for each direction of solar panel expansion.

In an alternative embodiment, a pulley system combined with a compression or expansion spring is used. When the solar module 43 is in a contracted modality 41, the pulley system expands such that the excess cables 35 are held between the two pulley blocks. When the solar module 43 is in an expanded modality 42, the pulley blocks are contracted and consequently the excess cable that comes out of the pulley system is used to help with the solar module 43 expansion 42. The compression or expansion springs help expand and contract the pulley blocks appropriately. The springs help ensure the cables in the pulleys can correctly retract without causing any tangling.

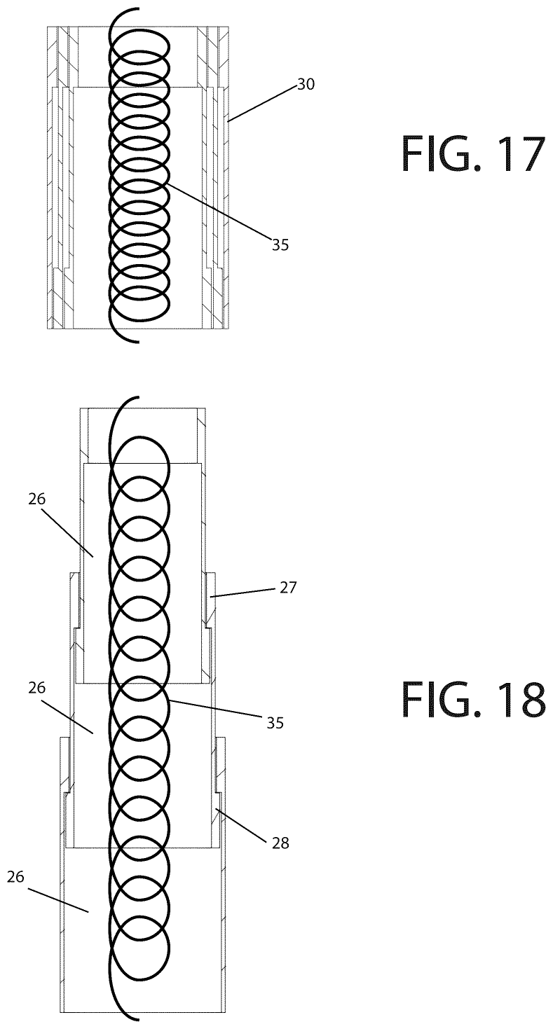

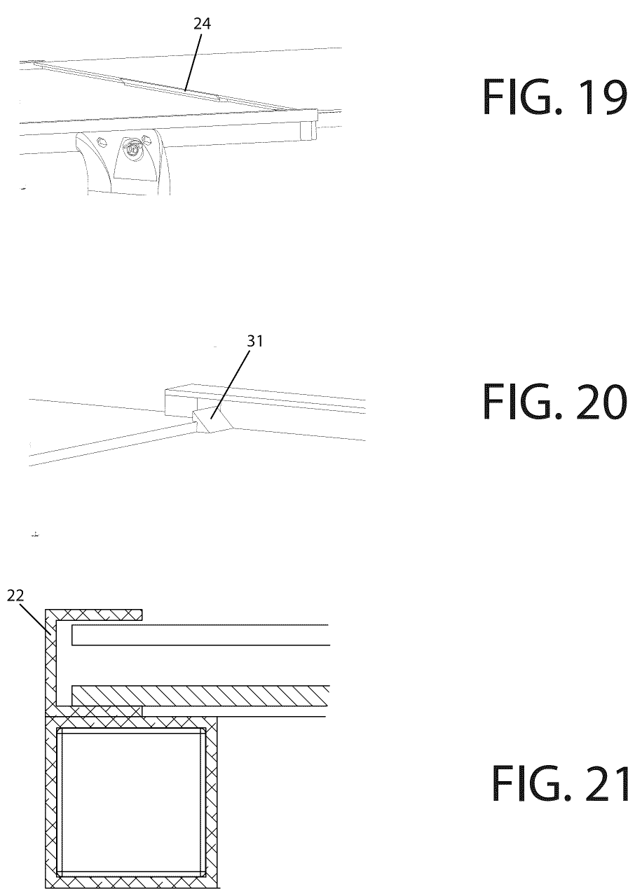

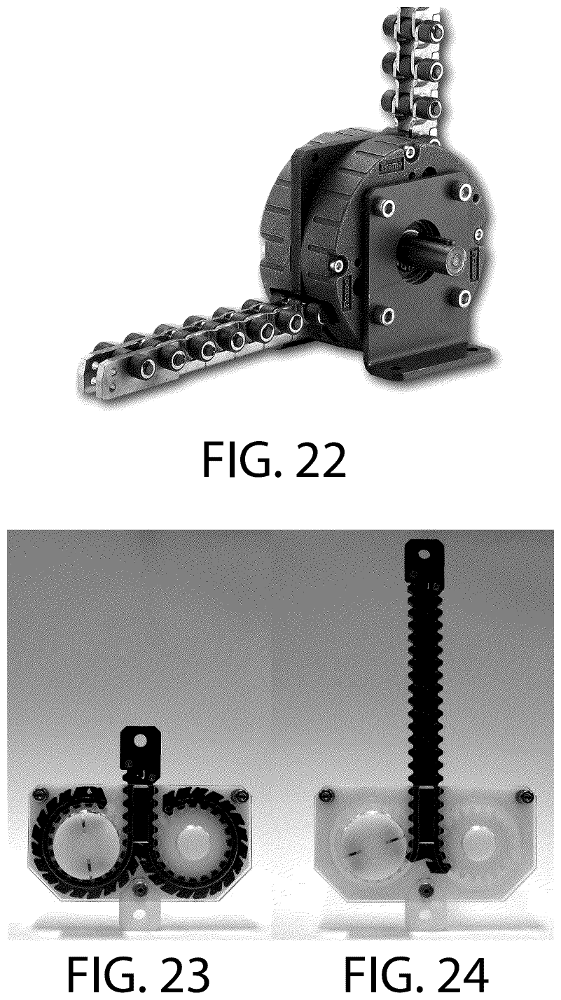

In an alternative embodiment, the electrical cables are coiled cables held within the telescopic arms 30 (FIGS. 17, 18). Such coiled cables expand and contract without losing their original shape. Examples of coiled cables include the cable 35 that connects the handset of a wall-mounted wired telephone from the 1980s, or system communication cables used in vehicles. In this mechanism, the cable storage and cable pulling function are both located in the elastic properties of the cable insulation that allows the coils to always contract and retain its shape.

In an alternative embodiment, the solar panels 40 that expand have bus bar extensions underneath them, and the static solar panel of the same solar module has magnetic connectors at the ends. The orientation of the bus bar extensions and magnetic endpoints is such that, when the solar panels 40 are fully expanded the magnetic endpoints touch, allowing electric current to flow.

In the preferred embodiment, the present invention comprises a double-chain system 34 that can expand and contract the telescopic arms 30. A double-chain system 34 is typically stored in two spirals containers 33 when in contracted form. One side of the chain 34 is stored in each spiral. Both spirals are mirror images placed next to each other. One or two servos working in sync expand the double-chain 34. As the two chains meet expand, the connected double-chain system 34 does not bend as it forms a zipper-like structure that is rigid.

In an alternative embodiment, single locking chains 34 are used for the actuator driven mechanical expansion. Single locking chains 34 are stored in spiral containers 33 when in contracted form 41. To expand the solar panels 40, the spiral container 33 turns forcing the single locking chain 34 into a telescopic arm 30. To contract, the spiral container 33 turns in the opposite direction. An alternative embodiment would use the single locking chain 34 outside of the telescopic arm 30 to apply force on the handlebar 25 to enable expansion and contraction.

In an alternative embodiment, the present invention further comprises mechanical and electrical expansion and contraction systems triggered by remote control, such that a user can expand and contract the solar panel array 10 from a distance. The preferred embodiment would also have programmatic endpoints, or APIs, such that software layers can trigger the expansion and contraction of the solar modules 43.

Most vehicles' roof racks create significant space between the vehicle's roof and the supporting cross beams. Due to its lightweight design and focus on reducing aerodynamic drag, this invention does not necessitate such large clearances.

In a preferred embodiment, the present invention's bottom frame attaches directly to the vehicle's roof hinges, eliminating the need for an aftermarket roof rack. Directly attaching the present invention to the roof of a vehicle has many benefits: (1) the clearance between the roof of the vehicle 11 and the bottom frame can be minimized improving the aesthetic look and design of the invention, (2) the aerodynamic drag loss is reduced, (3) cabin aerodynamic background noise is reduced, (4) economically, the user does not need to purchase a separate aftermarket roof rack, (5) the invention can be surrounded by a hard-shell skirt, windbreaker, and vortex breaker such that the aerodynamic drag loss is further reduced by partially integrating the invention to the body of the vehicle itself.

In a preferred embodiment, the control system 50 further comprises software to detect the vehicle's state. The awareness of state can also be one-directional, for example, only the present invention is aware of the vehicle's state. Given state awareness, the following actions can be performed programmatically: (1) deploy selective solar panels 40, (2) contract selective solar panels 40, (3) charge the vehicle 11, (4) stop charging the vehicle 11, (5) trigger alerts and alarms related to unsafe conditions, such as: (i) too much wind, (ii) bad weather, (iii) faulty electrical systems.

Such state awareness allows either the vehicle or the preferred embodiment to trigger actions. In an alternative embodiment, the invention has a central processing unit (CPU), on board memory, a storage or persistence device, and wired and wireless communication channels, such that it can: (i) interpret the state of the vehicle, (ii) receive external triggers via an API or app, (iii) use decision making rules to perform any of the actions listed above.

In an alternative embodiment, the present invention further comprises makes use of cameras 51 to make such programmatic decisions. Such camera systems connect to the CPU of the vehicle or the control system 50, allowing the programmatic layer to sense the available space surrounding the vehicle 11 such that specific solar 40 panels can be deployed in a safe manner.

The present invention is advantageous over the prior art for several reasons. First, the present invention is modular: it will fit various types of vehicles 11, large or small, by adjusting the number of solar panels 40 and the length of the telescoping arms 30. The present invention is efficient: high-efficiency solar panels 40 coupled with the ability to adjust the solar panel array's size mean that more electricity can be generated compared to fixed systems. The solar panels 40 can also be bifacial since the expanded solar array and consequently its solar panels 40 are floating in mid-air. The telescopic arms 30 provide a strong and light mechanical structure to deploy the solar panels 40. Many compact electric vehicles have a maximum rooftop weight capacity, by using composite materials and telescopic arms 30, the present invention can be used even when rooftop weight capacity is limited. The present invention is versatile: the system is ideal for a range of applications beyond just powering the vehicle 11, such as supplying power to auxiliary systems or serving as an emergency power source for a home. Lastly, the present invention is aerodynamic: the system minimizes its height and consequently its aerodynamic drag, thus having a minimal impact on the vehicle's fuel efficiency.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A solar panel array comprising
a frame;
a plurality of telescoping arms attached to said frame; and
a plurality of solar panels attached to said telescoping arms;
wherein said plurality of telescoping arms are used for the expansion and contraction of said plurality of solar panels to create an expandable and contractable solar panel array that is attached on the rooftop of a vehicle.

2. The solar panel array of claim 1, further comprising C-channels integrated into the frame for guiding the solar panels during expansion and contraction.

3. The solar panel array of claim 1, wherein the telescoping arms are configured to extend in laterally, enabling the expansion of the solar panel array to expand to any side of the vehicle.

4. The solar panel array of claim 1, wherein the telescoping arms are configured to extend in longitunally, enabling the expansion of the solar panel array to expand to any front and back of the vehicle.

5. The solar panel array of claim 1, wherein the system includes safety locks to prevent accidental expansion of the solar panels while the vehicle is in motion.

6. The solar panel array of claim 1, wherein said frame is configured to attach to a roof rack of a vehicle.

7. The solar panel array of claim 1, wherein said frame is configured to removably attach directly to the roof of a vehicle.

8. The solar panel array of claim 1, wherein said telescoping arms, said solar panels, and other components are equipped with over-extension locks to prevent over-extension of the solar panel array.

9. The solar panel array of claim 1, wherein the solar panels are bifacial, capable of generating electricity from sunlight on both sides of the panels.

10. The solar panel array of claim 1, wherein the solar panels are configured to be thin, light, and are enclosed in a durable, transparent coating for protection against environmental conditions.

11. The solar panel array of claim 1, further comprising a cable extension mechanism for managing the extension and retraction of electrical cables as the solar panels expand and contract.

12. The solar panel array of claim 1, wherein the control system includes a plurality of mechanical and electrical linear actuators configured to expand and contract said plurality of solar panels automatically based on vehicle state or user input.

13. The solar panel array of claim 1, further comprising a plurality of junction boxes associated with said plurality of solar panels, wherein said junction boxes are positioned on the edge within said frame such that said plurality of solar panels can stack more easily.

14. The solar panel array of claim 1, further comprising a control system electrically connected to said solar panel array, wherein said control system further comprises a means charging of an electric vehicle.

15. The solar panel array of claim 14, wherein said plurality of solar panels can be connected in series or in parallel depending on the needs of the electric vehicle.

16. The solar panel array of claim 14, wherein said control system further comprises a means for directly connecting to the charging system of a vehicle directly without the need for using the external charging port.

17. The solar panel array of claim 14, wherein said control system further comprises a central processing unit (CPU) with on-board memory and storage configured to communicate with said vehicle and external devices via wired or wireless communication channels.

18. The solar panel array of claim 14, wherein said control system is configured to interact with a software layer, enabling programmatic control and remote triggering of the expansion and contraction of the solar panels through the actuator.

19. The solar panel array of claim 14, further comprising a plurality of sensors and cameras configured to monitor the surroundings and ensure safe expansion and contraction of the solar panels.

20. The solar panel array of claim 14, further comprising a plurality of adjustable roof connectors 23 mechanically connected to said frame and said vehicle, wherein said adjustable roof connectors 23 are configured to adjust the angle of said solar panel array towards the sun.
